(19) United States
(12) Patent Application Publication
(10) Pub. No.: US 2006/0166025 A1
(43) Pub. Date: Jul. 27, 2006

(54) Plywood with carbon fabric and manufacturing method thereof

(75) Inventor: Fu-Kung Huang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/311,540

(22) Filed: Dec. 20, 2005

(30) Foreign Application Priority Data
Jan. 24, 2005 (TW) 94102052

(51) Int. Cl. B29C 65/00; B32B 21/08

(52) U.S. Cl. 428/535; 156/307.7

(57) ABSTRACT

The plywood composed by carbon fabrics and veneers and method of manufacturing thereof are disclosed. Several layers of carbon fabrics and veneers are symmetrically placed within the plywood, where a hot-melt adhesive is used to adhere the adjacent layers. Further, a suitably high temperature and high pressure are provided at the same time to melt the hot-melt adhesive and make the carbon fabrics and veneers adhere tightly. This plywood composed by carbon fabrics and veneers has a higher toughness and thinner thickness compared with conventional plywood.

### RELATED APPLICATIONS

The present application is based on, and claims priority from, Taiwan Application Serial Number 94102052, filed Jan. 24, 2005, the disclosure of which is hereby incorporated by reference herein in its entirety.

### BACKGROUND OF THE INVENTION

1. Field of Invention

The invention generally relates to plywood and the manufacturing method thereof, in particular, to plywood with carbon fabric and manufacturing method thereof.

2. Related Art

Traditionally, plywood is composed by several layers of veneers disposed in parallel and adhered together using a hot-melt adhesive (such as urea resin). This type of plywood provides the feeling close to natural wood because it is made of solid veneers. It is widely used in daily life. For example, using this kind of plywood on furniture can provide a natural wood outlook. However, the toughness of a single piece of veneer is insufficient. The number of veneers usually is increased to increase the strength of the plywood. For example, plywood may contain three to five layers of veneers. This method inevitably increases the thickness of the plywood. That is, the conventional plywood cannot achieve the advantages of small thickness and high toughness simultaneously. This fact restricts the applications of its products.

### SUMMARY OF THE INVENTION

To achieve a higher strength and smaller thickness and to maintain the feeling of natural wood, the invention provides plywood whose structure contains several layers of light and thin carbon fabrics that have better mechanical properties than veneers.

An embodiment of the invention provides plywood composed by carbon fabrics and veneers. In particular, the plywood includes carbon fabric to make it lighter, thinner, and stronger than a conventional plywood. Moreover, the upper and lower outer layers of the plywood are still made of the veneer to maintain the feeling of natural wood.

The embodiment of the invention provides a manufacturing method of the plywood composed by carbon fabrics and veneers. In accordance with the method, several layers of carbon fabrics and several layers of veneers are stacked inside the plywood. A hot-melt adhesive is used to adhere the layers together. The adhered layers of carbon fabrics and veneers are then disposed in a molding apparatus. Appropriate heat and pressure are imposed on the adhered layers to form the desired plywood.

In a preferred embodiment, an odd number of veneer layers and an even number of carbon fabric layers are stacked in parallel into a compound stack of materials. The upper, lower, and middle layers of the compound stack of materials are veneers symmetrically placed within the plywood. Carbon fabric layers are also placed symmetrically in the compound stack of materials. Adhesive layers are applied to both surfaces of the stacked layers, which layers are then sent into a molding apparatus for imposing appropriate heat and pressure simultaneously. Afterwards, the temperature of the molding apparatus is lowered. Once the adhesive between the layers cures, the pressure is removed. The plywood composed by carbon fabrics and veneers is formed.

The outlook of the disclosed plywood still maintains the features and texture alike natural wood. The carbon fabrics inside the stacked layers can increase the toughness and reduce the thickness and weight of the plywood. Therefore, the disclosed plywood is lighter, thinner, and yet stronger than the prior art. It has a wider range of applications than the conventional plywood. For example, it can be used in products for vehicles, electronics, furniture, and indoor decorations.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a flowchart showing how to make the disclosed plywood according to an embodiment of the invention;

FIG. 2A shows three-layer plywood made in accordance with a preferred embodiment of the invention and its cross-sectional view;

FIG. 2B shows a seven-layer plywood made in accordance with a preferred embodiment of the invention and its cross-sectional view; and

FIG. 3 is a cross-sectional view of another plywood manufactured according to a preferred embodiment of the invention.

### DETAILED DESCRIPTION OF THE PREFERRED EMBODIMENT

The present invention will be apparent from the following detailed description, which proceeds with reference to the accompanying drawings, wherein the same references relate to the same elements.

We use preferred embodiments to disclose plywood composed by carbon fabrics and veneers and the manufacturing method thereof. Any person skilled in the art can readily understand and implement the invention from the following description.

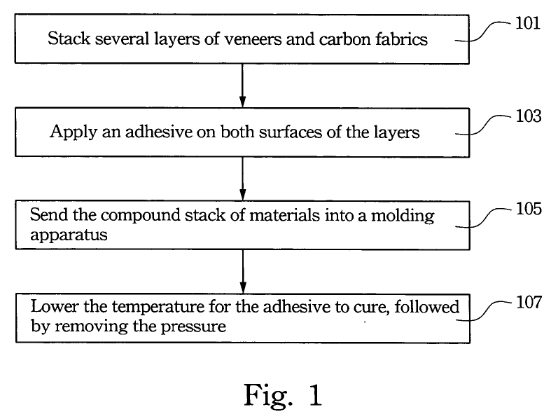

A flowchart of manufacturing the plywood is given in FIG. 1. In step 101, an odd number of veneer layers and an even number of carbon fabric layers are disposed in parallel to form a compound stack of materials. In particular, the upper, lower, and middle layers are the veneer layers placed symmetrically. Likewise, the carbon fabrics are placed symmetrically in the plywood. In step 103, an adhesive is applied on both surfaces of each stacking layer. In step 105, the compound stack of materials is sent into a molding apparatus, where appropriate heat and pressure are imposed simultaneously so that the adhered layers do not fall apart. In step 107, the temperature of the molding apparatus is lowered. After the adhesive between the layers is cured, the pressure is removed. The plywood composed by carbon fabrics and veneers is formed.

Structure of Plywood with Carbon Fabrics

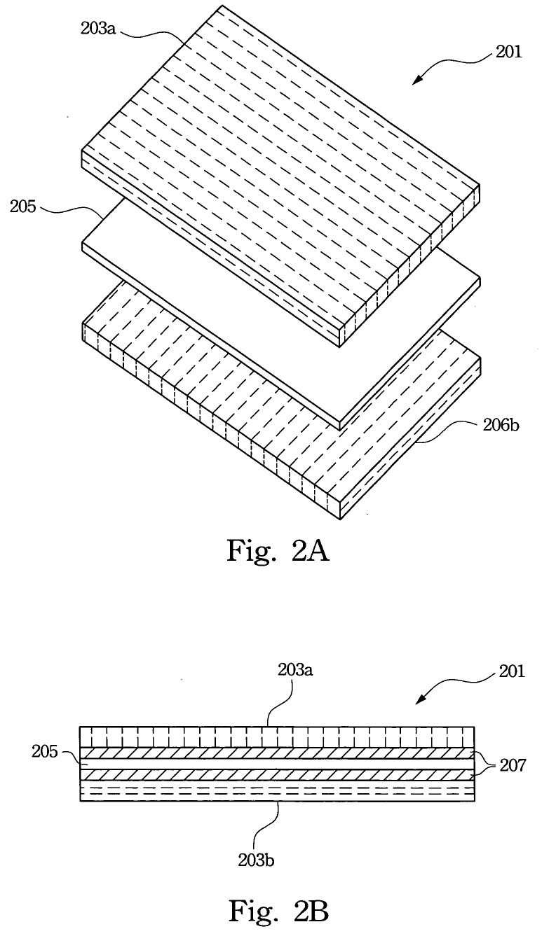

FIG. 2A is an exploded view of the three-layer plywood 201 made in accordance with a preferred embodiment of the invention. FIG. 2B is a cross-sectional view of the three-layer plywood 201. The outer layers of the three-layer plywood 201 are an upper veneer 203a and a lower veneer 203b. A carbon fabric 205 is between the upper veneer 203a and the lower veneer 203b. In particular, the textures of the upper veneer 203a and the lower veneer 203b are horizontal for one and vertical for the other. For example, if the upper veneer 203a has a horizontal texture, then the lower veneer 203b has to have a vertical texture. One advantage of this configuration is that they have complimentary effect to avoid cracks occurred in one particular direction. Moreover, an adhesive 207 is used to combine the three-layer plywood 201. In particular, the adhesive 207 preferably may be a hot-melt adhesive, such as urea resin.

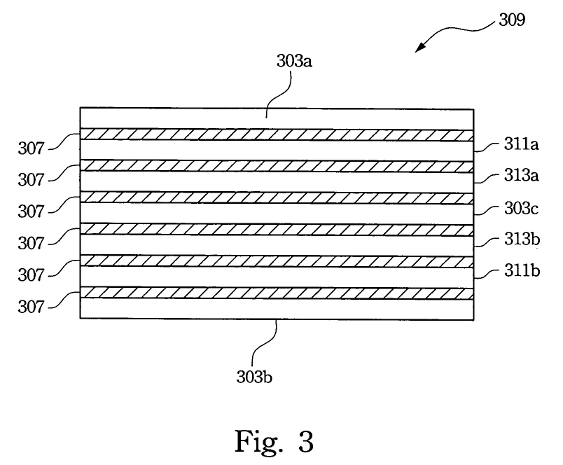

The number of layers in the disclosed plywood may be any odd number such as five and seven or more. FIG. 3 shows the cross-sectional view of another plywood 309 whose number of layers is seven. In this structure, the upper, lower and middle layers are an upper veneer 303a, a lower veneer 303b, and a middle veneer 303c. The other four layers 311a, 311b, 313a, and 311b may be veneers and/or carbon fabrics. It should be noted that these four layers have to be carbon fabrics and/or veneers placed symmetrically with respect to the middle veneer layer 303c. For example, if the layer 311a is a carbon fabric, then the layer 311b has to be a carbon fabric too. If the layer 313a is a veneer, then the layer 313b has to be a veneer too. Moreover, the veneers are disposed in such a way that their textures have to be perpendicular to each other to produce a complimentary effect. That is, if the layer 313a is a veneer and the layer 311a is a carbon fabric, then the textures of the upper veneer 303a, the layer 313a and the middle veneer 303c have to be vertical-horizontal-vertical or horizontal-vertical-horizontal. Besides, the number of carbon fabrics in the plywood 309 can vary according to different requires of the final product. For example, the plywood 309 may contain two or four layers of carbon fabrics. Moreover, the plywood 309 uses an adhesive 307 to combine the layers. In particular, the adhesive 307 preferably may be a hot-melt adhesive, such as the urea resin.

It should be mentioned that the disclosed plywood uses carbon fabrics in place of conventional veneers as the inner layers. Since the thickness of a single piece of carbon fabric (about 0.5 mm) is smaller than that of a single piece of veneer (about 1˜1.5 mm), the thickness of the disclosed products can be significantly reduced.

Another advantage of the disclosed plywood is that its toughness is far better than the conventional veneer plywood of the same thickness. In the case of same layers, the disclosed plywood is stronger than the conventional veneer plywood at least by a factor of three.

It is thus seen that the disclosed plywood with carbon fabrics is thinner, lighter, and yet stronger than the conventional plywood.

Manufacturing Method of the Plywood with Carbon Fabrics

In a preferred embodiment, an odd number of veneer layers and an even number of carbon fabric layers are disposed in parallel according to the above-mentioned method to form a compound stack of materials (see FIGS. 2B and 3). In particular, the number of layers in the compound stack of materials has to be odd. The inner layers are symmetric in structure. An adhesive coating machine is used to apply an adhesive on both surfaces of the layers for adhering adjacent layers together. The adhesive preferably may be a hot-melt adhesive, such as urea resin. Using a hot-melt adhesive has the advantages of fast curing, stable properties, and suitable for combining many different materials. Therefore, the adhesive can provide the required adhesive ability at the veneer/veneer, veneer/carbon fabric, and carbon fabric/carbon fabric junctions. The compound stack of materials is sent into a molding apparatus where appropriate heat and pressure are imposed. If a steel mold is used to impose a pressure, the thickness of the pressure-imposing material is about 12 mm and the heating temperature is between 90° C. and 110° C. The imposed pressure is between 95 lb. and 105 lb. The molding time is between 10 min. and 15 min. The temperature is lowered for the adhesive between the layers to cure, after which the pressure is then removed. The plywood has the upper and lower layers of veneers and carbon fabrics disposed in between.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A plywood, comprising:
an upper veneer;
a lower veneer;
a first carbon fabric placed between the upper veneer and the lower veneer; and
a plurality of adhesive layers placed between the upper veneer and the first carbon fabric and between the first carbon fabric and the lower veneer.

2. The plywood of claim 1, further comprising a middle veneer placed between the upper veneer and the first carbon fabric.

3. The plywood of claim 1, further comprising another carbon fabric placed between the upper veneer and the first carbon fabric.

4. The plywood of claim 1, further comprising a middle veneer placed between the first carbon fabric and the lower veneer.

5. The plywood of claim 1, further comprising another carbon fabric placed between the first carbon fabric and the lower veneer.

6. The plywood of claim 1, wherein the adhesive layers include urea resin.

7. A plywood with symmetrically placed materials, comprising:
an upper veneer;
a lower veneer;
a middle veneer placed between the upper veneer and the lower veneer;
an even number of carbon fabric layers placed between the upper veneer and the lower veneer and arranged in a symmetrical way with respect to the middle veneer; and
a plurality of adhesive layers placed between the upper veneer the lower veneer to adhere the veneers and the carbon fabrics.

8. The plywood of claim 7, wherein the even number of veneers are placed between the upper veneer and the lower veneer in a symmetrical way with respect to the middle veneer.

9. The plywood of claim 7, wherein the materials in the adhesive layers include at least urea resin.

10. A method of manufacturing plywood, comprising the steps of:
stacking a plurality of veneers and at least one carbon fabric alternately to form a structure;
applying adhesive layers between the veneers and the carbon fabric in the structure;
imposing appropriate pressure and temperature on the structure; and
removing the pressure and lowering the temperature to obtain plywood containing the carbon fabric and the veneers.

11. The method of claim 10, wherein the number of layers in the structure is odd.

12. The method of claim 10, wherein the number of the carbon fabrics in the structure is larger than two, and the positions of the carbon fabrics in the structure are symmetric with respect to the center of the structure.

13. The method of claim 10, wherein the adhesive layers includes urea resin.
